(19) United States
(12) Patent Application Publication
(10) Pub. No.: US 2017/0212829 A1
(43) Pub. Date: Jul. 27, 2017

(54) Deep Learning Source Code Analyzer and Repairer

(71) Applicant: American Software Safety Reliability Company, Atlanta, GA (US)

(72) Inventors: Benjamin Bales, Atlanta, GA (US); Arkadiy Miteiko, Atlanta, GA (US); Blake Rainwater, Roswell, GA (US)

(73) Assignee: American Software Safety Reliability Company

(21) Appl. No.: 15/410,005

(22) Filed: Jan. 19, 2017

Related U.S. Application Data
(60) Provisional application No. 62/281,396, filed on Jan. 21, 2016.

(51) Int. Cl. G06F 11/36; G06F 9/45; G06F 9/44

(52) U.S. Cl. CPC G06F 11/3664; G06F 8/71; G06F 8/433; G06F 11/3612

(57) ABSTRACT

A deep learning source code analyzer and repairer trains neural networks and applies them to source code to detect defects in the source code. The deep learning source code analyzer and repairer can also use neural networks to suggest modifications to source code to repair defects in the source code. The neural networks can be trained using versions of source code with potential defects and accepted modifications addressing the potential defects.

### CROSS REFERENCE TO RELATED APPLICATIONS

This application claims the benefit of the filing date of provisional patent application U.S. App. No. 62/281,396, titled “Deep Learning Source Code Analyzer and Repairer,” filed on Jan. 21, 2016, the entire contents of which are incorporated by reference herein.

### BACKGROUND

One of the primary tasks in the software development life cycle is validation and verification (“V&V”) of software. The primary goal of validation and verification is identifying and fixing defects, or “bugs,” in the source code of the software. A defect is an error that causes the software to produce an incorrect or unexpected result or behave in unintended ways when executed. Most defects in software come from errors made by developers while designing or implementing the software. While developers can introduce defects during the specification and design phases of the software life cycle, they frequently introduce defects when writing source code during the implementation phase.

Software containing a large number of defects or defects that seriously interfere with its functionality can be so harmful that the software no longer satisfies it intended purpose. Defects can also cause software to crash, freeze, or enable a malicious user to bypass access controls in order to obtain unauthorized privileges. Defects can be a serious problem for security and safety critical software. For example, defects in medical equipment or heavy machinery software can result in great bodily harm or death, and defects in banking software can lead to substantial financial loss. Due to the complexity of some software systems, defects can go undetected for a long period of time because the input triggering the defect may not have been supplied to the software during V&V before release. Also, the V&V procedure used by the developers of the software may not have traversed all execution branches of the software, and defects may occur in non-traversed branches.

For a typical multi-developer software project, source code under development is stored in a shared source code repository. As the project progresses, developers typically modify portions of the source code base or add new portions of code to a local copy of the shared source code repository. Developers' changes are merged into the source code when they “commit” their changes to the shared source code repository. Typically, when source code is compiled, linked, and/or otherwise prepared for execution, it is known as a “build” of the source code. A build of source code may fail due to syntax errors preventing the code to compile or the failure to include a referenced source code library. These failures can typically be corrected by developers relatively quickly and since they prevent execution of the source code, build failures do not propagate to V&V. But, successfully built source code is not necessarily free of errors or defects, which is why developers may perform V&V procedures before releasing the build. In an iterative software development model, V&V is typically performed on builds of the shared source code repository after a development milestone or on a periodic basis. For example, V&V may be done nightly, weekly, or according to specified dates in the software project development schedule.

One form of V&V is unit testing. In unit testing individual units of source code are tested against unit tests to determine whether they are functioning properly. Unit tests are short code fragments created by developers that supply inputs to the source code under test, and the unit test passes or fails depending on the actual output of the source code under test when compared to an expected output for the given input values. For this reason, unit tests are considered a form of “black-box” testing. In some cases, unit tests automatically obtain outputs from the source code under test and programmatically compare the outputs to the expected results. Ideally, each unit test is independent from others and is meant to test a small enough portion of source code so defects can be localized and mapped to lines of source code easily. Generally, unit testing is a form of dynamic source code testing as the unit tests are run based on an executable code build.

Like other dynamic source code testing, unit testing is limited because it requires the source code to be built and executed. In addition, unit testing by definition only tests the functionality of the source code unit under test, so it will not catch integration defects between source code units or broader system-level defects. Unit testing can also require extensive man-hours to implement. For example, every boolean decision in source code requires at least two tests: one with an outcome of “true” and one with an outcome of “false.” As a result, for every line of source code, developers often need at least 3 to 5 lines of test code. Also, some applications such as nondeterministic or multi-threaded applications cannot be tested easily with unit tests. Finally, since developers write unit tests, the unit test itself can be as defective as the code it is attempting to test.

Traditionally, once source code has passed unit testing, integration testing occurs. Like unit testing, integration testing is a dynamic testing method that typically uses a black-box model—testers apply inputs to integrated source code units and observe outputs. The testers compare the observed outputs to desired outputs. In some cases, integration testing is performed by human testers according to an integration plan, but some software tools exist for dynamic software testing. A major limitation of integration testing is that any conditions not in the integration test plan will not be tested. Thus, defects can end up in deployed and released software lying in wait for the conditions that trigger it.

Another form of black-box testing is fuzz testing. In fuzz testing, random inputs are provided to the source code to determine failures. The inputs are chosen based on maximizing source code coverage—inputs resulting in execution of the most lines of code are provided with the goal of traversing each line of code in the source code base.

Another form of traditional V&V testing is “white-box” testing. White-box testing tests the internal structures or paths through an application. This is sometimes done via breakpoints in the code, and when the code executes to that breakpoint, developers can check the state of one or more conditions against expected values to confirm the software is operating properly. Like the black-box testing described above, white-box testing is dependent upon developers to implement. Based on the quality of testing plan, defects can remain in the source code even after it has passed a white-box V&V test procedure.

An alternative, or complement, to dynamic testing is static code analysis. Static code analysis is a V&V method that is performed on source code without execution. One common static code analysis technique is pattern matching. In pattern matching, a static code analysis tool creates an abstraction of the source code, such as an abstract syntax tree (“AST”)—a tree representation of the source code's structure—or a control flow graph (“CFG”)—a graphic notation representation of all paths that might be traversed through a program during its execution. The tool compares the created abstraction of the source code to abstraction patterns containing defects. When there is a match, the corresponding source code for the abstraction is flagged as a defect. Pattern matching can also include a statistical component that can be customized based on the best practices of a particular organization or application domain. For example, a static code analysis tool may identify that for a particular operation, the source code performing the operation has a corresponding abstraction 75% of the time. If the static code analysis tool encounters the same operation in source code it is analyzing, but the abstraction for the source code performing the operation does not match the 75% case, the static code analysis tool flags the source code as a defect.

While pattern matching is the most common, other static code analysis techniques exist. One such technique is symbolic execution. In symbolic execution, variables are replaced with symbolic variables representing a range of values. Simulated execution of the source code occurs using the range of values to identify potential error conditions. Other techniques use so-called “formal methods” or semantics. Formal methods use technologies similar to compiler optimization tools to identify potential defects. While formal method techniques are more sound, they are computationally expensive. For example, a static code analysis tool using formal methods may take several days to analyze a given source code base while a static code analysis tool using pattern matching may take an hour to analyze the same source code base. Some static analysis tools use mathematical modeling techniques to create a mathematical model of source code which is then checked against a specification—a process called model checking. If the model complies with the specification, the source code is said to be free of defects. But, since mathematical modeling uses a specification for V&V, it cannot detect defects due to errors in the specification. Another disadvantage to mathematical modeling is that it only informs developers if there is a defect in the analyzed code and it cannot detect the location of the defect.

Software developers can use static analysis to automatically uncover errors typically missed by unit testing, system testing, quality assurance, and manual code reviews. By quickly finding and fixing these hard-to-find defects at the earliest stage in the software development life cycle, organizations are saving millions of dollars in associated costs. Since static code analysis aims to identify potential defects more accurately than black-box testing, it is especially popular in safety-critical computer systems such as those in the medical, nuclear energy, defense, and aviation industries. While static code analysis tools can yield better V&V results than dynamic analysis methods, they are still not accurately identifying enough defects in source code. As software has gotten more complex, defect densities (typically measured in defects per lines of code) in deployed and released software have been increasing despite the use of the V&V methods described above, including static code analysis tools.

Current static code analysis tools also generate a high number of false positives. A false positive is when the tool identifies code as a defect, but it is not actually a defect. The most accurate and sophisticated static code analysis tools currently available have false positive rates from 10-15%. False positives create many problems for developers. First, false positives introduce waste of man-hours and computational resources in software development as time, equipment, and money must be allocated toward addressing false positives. Second, a typical software development project has a backlog of defects to fix and retest, and often not every defect is addressed due to time or budget constraints. False positives further exacerbate this problem by introducing entries into the defect report that are not really defects. Finally, false positives may lead to developer abandonment of the static code analysis tools because false positives create too much disruption to V&V procedures to be worth using.

Another limitation of static code analysis tools is that while they may be able to identify and potentially locate defects, they do not automatically fix the defects. Although some tools may identify the category or nature of the defect, provide limited guidance for fixing the defect, or provide an example template on how to fix the defect, current tools in the art do not make specific source code repair suggestions based on the context of the source code it is analyzing.

### SUMMARY

The disclosed methods and systems, in some aspects, train and apply neural networks to detect defects in source code without compiling or interpreting the source code. The disclosed methods and systems, in some aspects, also use neural networks to suggest modifications to source code to repair defects in the source code without compiling or interpreting the source code.

In one aspect, a method generates a source code defect detector. The method obtains a first version of source code including one or more defects and a second version of the source code including a modification to the first version of the source code addressing the one or more defects. The method generates a plurality of selected control flows based on the first version of the source code and the second version of the source code, the plurality of selected control flows including first control flows representing potentially defective lines of the source code and second control flows including defect-free lines source code. The method generates a label set including data elements corresponding to respective members of the plurality of selected control flows. The data elements of the label set represent an indication of whether its respective member of the plurality of selected control flows contains a potential defect or is defect-free. The method trains a neural network using the plurality of selected control flows and the label set.

Implementations of this aspect may include comparing a first control flow graph corresponding to the first version of source code to a second control flow graph corresponding to the second version of the source code to identify the first control flows and the second control flows when generating the plurality of selected control flows. Implementations may also include transforming the first version of the source code into a first plurality of control flows and transforming the second version of the source code into a second plurality of control flows when generating the first and second control flow graphs. In some implementations, the method uses abstract syntax trees to transform the first and second versions of the source code into the first and second plurality of control flows. In some implementations, the method normalizes the variables in the first and second abstract syntax trees. The method may also include encoding the plurality of selected control flows into respective vector representations using one-of-k encoding or an embedding layer. In some implementations, the method assigns a first subset of the plurality of selected control flows to respective unique vector representations and assigns a second subset of the plurality of selected control flows a vector representation corresponding to an unknown value when encoding the plurality of selected control flows. In some implementations, the method obtains metadata describing one or more defect types, selects a defect of the one or more defect types, and the source code is limited to lines of code including defects of the selected defect. In some implementations, the neural network is a recurrent neural network. Training the neural network, in some implementations, includes applying the plurality of selected control flows as input to the neural network and adjusting weights of the neural network so that the neural network produces outputs matching the plurality of selected control flows for respective data elements of the label set.

Other embodiments of this aspect include corresponding computer systems, apparatus, and computer programs recorded on one or more computer storage devices, each configured to perform the actions of the methods.

In another aspect, a system for detecting defects in source code includes processors and computer readable media storing instructions that when executed cause the processors to perform operations. The operations may include generating one or more control flows for first source code corresponding to execution paths and generating a location map linking the one or more control flows to locations within the source code. The operations may also include encoding the one or more control flows using an encoding dictionary. Faulty control flows can be identified by applying the one or more control flows as input to a neural network trained to detect defects in the first source code, wherein the neural network was trained using second source code of the same context as the first source code and was trained using the encoding dictionary. The operations correlate the faulty control flows to fault locations within the first source code based on the location map.

Implementations of this aspect may include providing the fault locations to a developer computer system, which may be provided to the developer computer system as instructions for generating a user interface displaying the fault locations in some implementations. In some implementations, the operations may generate the one or more control flows by generating an abstract syntax tree for the first source code.

Other embodiments of this aspect include methods performing one or more of the operations described above.

In another aspect, a method for repairing software defects includes performing one or more defect detection operations on an original source code file to identify a defect of a defect type in first one or more lines of source code. The method may also provide the first one or more lines of source code to a first neural network—trained to output suggested source code to repair defective source code of the defect type—to generate second one or more lines of source code. The method may replace the first one or more lines of source code in the original source code file with the second one or more lines of source code to generate a repaired source code file and may validate the second one or more lines of source code by performing the one or more defect detection operations on the repaired source code file.

Implementations of this aspect may include executing a test suite of test cases against an executable form of the original source code file and the repaired source code file as part of performing the one or more defect detection operations. The defect detection operations may include applying control flows of source code to a second neural network trained to detect defects of the defect type, in some implementations. Validating the second one or more lines of source code may include providing the second one or more lines of source code to a developer computer system for acceptance, and in some implementations, the second one or more lines of source code are provided to the developer computer system with instructions for generating a user interface that can display the first one or more lines of source code, the second one or more lines of source code, and a user interface element that when selected communicates acceptance of the second one or more lines of source code.

Other embodiments of this aspect include corresponding computer systems, apparatus, and computer programs recorded on one or more computer storage devices, each configured to perform the actions of the methods.

### BRIEF DESCRIPTION OF THE DRAWINGS

Reference will now be made to the accompanying drawings which illustrate exemplary embodiments of the present disclosure and in which:

FIG. 1 illustrates, in block form, a network architecture system for analyzing source code and repairing source code consistent with disclosed embodiments;

FIG. 2 illustrates, in block form, a data and process flow for training an artificial neural network to detect defects in source code consistent with disclosed embodiments;

FIG. 3 illustrates, in block form, a data and process flow for detecting defects in source code using a trained artificial neural network consistent with disclosed embodiments;

FIG. 4 illustrates, in block form, a data and process flow for fixing defects in source code consistent with disclosed embodiments;

FIG. 5 is a flowchart representation of an interactive source code repair process consistent with the embodiments of the present disclosure;

FIG. 6 is a screenshot of an exemplary depiction of a graphical user interface consistent with embodiments of the present disclosure;

FIG. 7 illustrates, in block form, a computer system with which embodiments of the present disclosure can be implemented; and

FIG. 8 illustrates a recurrent neural network architecture consistent with embodiments of the present disclosure.

### DETAILED DESCRIPTION

Reference will now be made in detail to exemplary embodiments of systems and methods for source code analysis and repair, examples of which are illustrated in the accompanying drawings. Wherever possible, the same reference numbers will be used throughout the drawings to refer to the same or like parts. The terminology used in the description presented herein is not intended to be interpreted in any limited or restrictive manner, simply because it is being utilized in conjunction with a detailed description of certain specific embodiments. Furthermore, the described embodiments may include several novel features, no single one of which is solely responsible for its desirable attributes or which is essential to the systems and methods described herein.

About 10% of the defects detected by the most accurate and sophisticated static code analysis tools currently available are false positives. As a result, software development projects using static code analysis tools suffer from the above-discussed problems that false positives create. In addition, while static code analysis tools can be helpful for developers, some developers may decline to adopt them because of high false positive rates. In addition, current static code analysis tools do not have the capability of automatically fixing defects in source code, which would create further development efficiencies.

The shortcoming of current static code analysis tools are the methods by which they detect defects. Detecting defects using pattern matching techniques, for example, is limited. To improve false positives, and potentially identify more true positives when analyzing source code for defects, a different method is required.

Accordingly, the present disclosure describes embodiments of a source code analyzer and repairer that employs artificial intelligence and deep learning techniques to identify defects within source code. The embodiments discussed herein offer the advantage over conventional pattern matching static code analysis tools in that they are more effective at finding defects within source code and generate far fewer false positives. For example, embodiments of disclosed in the present disclosure have resulted in false positive rates as low as 3% in some tests. In addition, the embodiments described herein offer the ability to automatically fix some defects in source code, which leads to fewer regression defects. And, as deep learning techniques can be trained continuously over time, the disclosed embodiments can become increasingly more accurate over time and can be customized for a particular software development organization or a particular technical domain.

Deep learning is a type of machine learning that attempts to model high-level abstractions in data by using multiple processing layers or multiple non-linear transformations. Deep learning uses representations of data, typically in vector format, where each datum corresponds to an observation with a known outcome. By processing over many observations with known outcomes, deep learning allows for a model to be developed that can be applied to a new observation for which the outcome is not known.

Some deep learning techniques are based on interpretations of information processing and communication patterns within nervous systems. One example is an artificial neural network. Artificial neural networks are a family of deep learning models based on biological neural networks. They are used to estimate functions that depend on a large number of inputs where the inputs are unknown. In a classic presentation, artificial neural networks are a system of interconnected nodes, called “neurons,” that exchange messages via connections, called “synapses” between the neurons.

An example, classic artificial neural network system can be represented in three layers: the input layer, the hidden layer, and the output layer. Each layer contains a set of neurons. Each neuron of the input layer is connected via numerically weighted synapses to nodes of the hidden layer, and each neuron of the hidden layer is connected to the neurons of the output layer by weighted synapses. Each neuron has an associated activation function that specifies whether the neuron is activated based on the stimulation it receives from its inputs synapses.

An artificial neural network is trained using examples. During training, a data set of known inputs with known outputs is collected. The inputs are applied to the input layer of the network. Based on some combination of the value of the activation function for each input neuron, the sum of the weights of synapses connecting input neurons to neurons in the hidden layer, and the activation function of the neurons in the hidden layer, some neurons in the hidden layer will activate. This, in turn, will activate some of the neurons in the output layer based on the weight of synapses connecting the hidden layer neurons to the output neurons and the activation functions of the output neurons. The activation of the output neurons is the output of the network, and this output is typically represented as a vector. Learning occurs by comparing the output generated by the network for a given input to that input's known output. Using the difference between the output produced by the network and the expected output, the weights of synapses are modified starting from the output side of the network and working toward the input side of the network. Once the difference between the output produced by the network is sufficiently close to the expected output (defined by the cost function of the network), the network is said to be trained to solve a particular problem. While the example explains the concept of artificial neural networks using one hidden layer, many artificial neural networks include several hidden layers.

While there are many artificial neural network models, some embodiments disclosed herein use a recurrent neural network. In a traditional artificial neural network, the inputs are independent of previous inputs, and each training cycle does not have memory of previous cycles. The problem with this approach is that it removes the context of an input (e.g., the inputs before it) from training, which is not advantageous for inputs modeling sequences, such as sentences or statements. Recurrent neural networks, however, consider current input and the output from a previous input, resulting in the recurrent neural network having a “memory” which captures information regarding the previous inputs in a sequence.

### Overview of Embodiments

In the embodiments disclosed herein, a source code analyzer collects source code data from a training source code repository. The training source code repository includes defects identified by human developers, and the changes made to source code to address those defects. The defects are categorized by type. For a given defect type, the source code analyzer can obtain a set of training data that can be used to train an artificial neural network whereby the training inputs are a mathematical representation (e.g., a sequence of vectors) of the source code containing the defect and the outputs are a mathematical representation of whether the code contains a defect.

Once the source code analyzer has sufficiently trained the artificial neural network, the network can be applied to source code to detect defects within it. Thus, the source code analyzer can obtain source code for an active software development project for which defects are not known, apply the model to the source code, and obtain a result indicating whether the source code contains defects.

In addition, the embodiments herein describe a source code repairer that can suggest possible fixes to defects in source code. In some embodiments, the source code repairer trains an artificial neural network using source code with known defects as input to the network and fixes to those defects as the expected outputs. The source code repairer can locate defects within source code using the techniques employed by the source code analyzer, or by using test cases created by developers. Once defects are located, the source code repairer can make suggestions to the code based on a trained artificial neural network model. The fix suggestions can be automatically integrated into the source code. In some embodiments, the suggestions can be presented to developers in their IDEs, and accepted or declined using a selectable user interface element.

### Network Architecture and Data Flows According To Some Embodiments

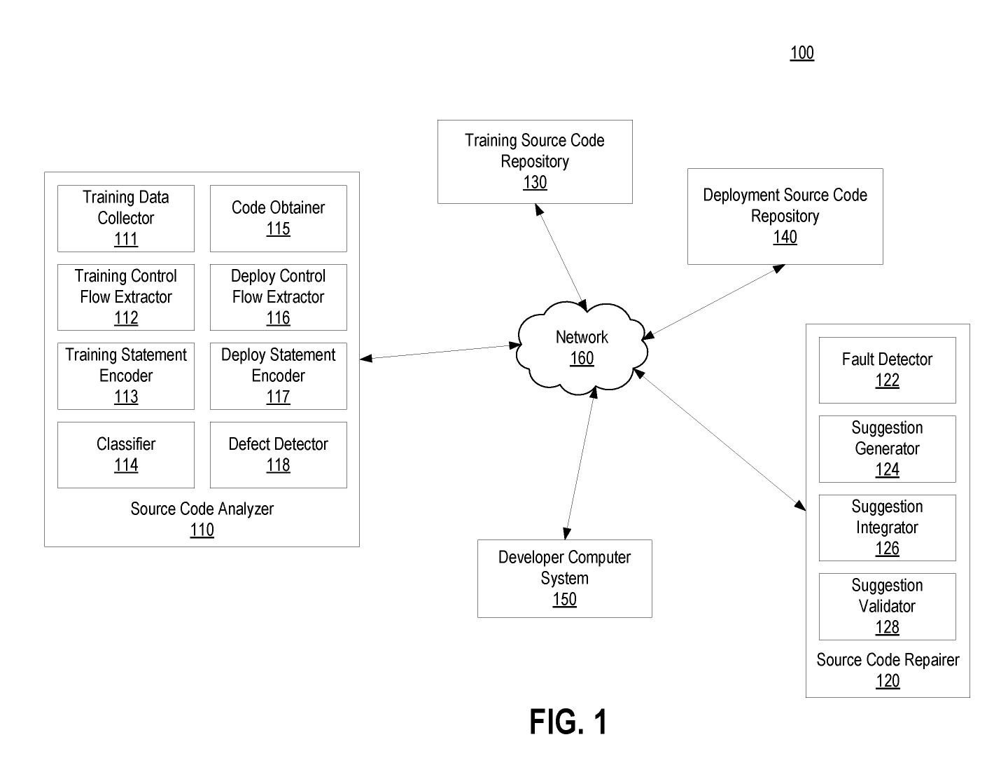

FIG. 1 illustrates, in block form, system 100 for analyzing source code and repairing defects in it, consistent with disclosed embodiments. In the embodiment illustrated in FIG. 1, source code analyzer 110, source code repairer 120, training source code repository 130, deployment source code repository 140, and developer computer system 150 can communicate with each other across network 160.

System 100 outlined in FIG. 1 can be computerized, wherein each of the illustrated components comprises a computing device that is configured to communicate with other computing devices via network 160. For example, developer computer system 150 can include one or more computing devices, such as a desktop, notebook, or handheld computing device that is configured to transmit and receive data to/from other computing devices via network 160. Similarly, source code analyzer 110, source code repairer 120, training source code repository 130, and deployment source code repository 140 can include one or more computing devices that are configured to communicate data via the network 160. In some embodiments, these computing systems would be implemented using one or more computing devices dedicated to performing the respective operations of the systems as described herein.

Depending on the embodiment, network 160 can include one or more of any type of network, such as one or more local area networks, wide area networks, personal area networks, telephone networks, and/or the Internet, which can be accessed via any available wired and/or wireless communication protocols. For example, network 160 can comprise an Internet connection through which source code analyzer 110 and training source code repository 130 communicate. Any other combination of networks, including secured and unsecured network communication links are contemplated for use in the systems described herein.

Training source code repository 130 can be one or more computing systems that store, maintain, and track modifications to one or more source code bases. Generally, training source code repository 130 can be one or more server computing systems configured to accept requests for versions of a source code project and accept changes as provided by external computing systems, such as developer computer system 150. For example, training source code repository 130 can include a web server and it can provide one or more web interfaces allowing external computing systems, such as source code analyzer 110, source code repairer 120, and developer computer system 150 to access and modify source code stored by training source code repository 130. Training source code repository 130 can also expose an API that can be used by external computing systems to access and modify the source code it stores. Further, while the embodiment illustrated in FIG. 1 shows training source code repository 130 in singular form, in some embodiments, more than one training source code repository having features similar to training source code repository 130 can be connected to network 160 and communicate with the computer systems described in FIG. 1, consistent with disclosed embodiments.

In addition to providing source code and managing modifications to it, training source code repository 130 can perform operations for tracking defects in source code and the changes made to address them. In general, when a developer finds a defect in source code, she can report the defect to training source code repository 130 using, for example, an API or user interface made available to developer computer system 150. The potential defect may be included in a list or database of defects associated with the source code project. When the defect is remedied through a source code modification, training source code repository 130 can accept the source code modification and store metadata related to the modification. The metadata can include, for example, the nature of the defect, the location of the defect, the version or branch of the source code containing the defect, the version or branch of the source code containing the fix for the defect, and the identity of the developer and/or developer computer system 150 submitting the modification. In some embodiments, training source code repository 130 makes the metadata available to external computing systems.

According to some embodiments, training source code repository 130 is a source code repository of open source projects, freely accessible to the public. Examples of such source code repositories include, but are not limited to, GitHub, SourceForge, JavaForge, GNU Savannah, Bitbucket, GitLab and Visual Studio Online.

Within the context of system 100, training source code repository 130 stores and maintains source code projects used by source code analyzer 110 to train a deep learning model to detect defects within source code, as described in more detail below. This differs, in some aspects, with deployment source code repository 140. Deployment source code repository 140 performs similar operations and offers similar functions as training source code repository 130, but its role is different. Instead of storing source code for training purposes, deployment source code repository 140 can store source code for active software projects for which V&V processes occur before deployment and release of the software project. In some aspects, deployment source code repository 140 can be operated and controlled by entirely different entity than training source code repository 130. As just one example, training source code repository 130 could be GitHub, an open source code repository owned and operated by GitHub, Inc., while deployment source code repository 140 could be an independently owned and operated source code repository storing proprietary source code. However, neither training source code repository 130 nor deployment source code repository 140 need be open source or proprietary. Also, while the embodiment illustrated in FIG. 1 shows deployment source code repository 140 in singular form, in some embodiments, more than one deployment source code repository having features similar to deployment source code repository 140 can be connected to network 160 and communicate with the computer systems described in FIG. 1, consistent with disclosed embodiments.

System 100 can also include developer computer system 150. According to some embodiments, developer computer system 150 can be a computer system used by a software developer for writing, reading, modifying, or otherwise accessing source code stored in training source code repository 130 or deployment source code repository 140. While developer computer system 150 is typically a personal computer, such as one operating a UNIX, Windows, or Mac OS based operating system, developer computer system 150 can be any computing system configured to write or modify source code. Generally, developer computer system 150 includes one or more developer tools and applications for software development. These tools can include, for example, an integrated developer environment or “IDE.” An IDE is typically a software application providing comprehensive facilities to software developers for developing software and normally consists of a source code editor, build automation tools, and a debugger. Some IDEs allow for customization by third parties, which can include add-on or plug-in tools that provide additional functionality to developers. In some embodiments of the present disclosure, IDEs executing on developer computer system 150 can include plug-ins for communicating with source code analyzer 110, source code repairer 120, training source code repository 130, and deployment source code repository 140. According to some embodiments, developer computer system 150 can store and execute instructions that perform one or more operations of source code analyzer 110 and/or source code repairer 120.

Although FIG. 1 depicts source code analyzer 110, source code repairer 120, training source code repository 130, deployment source code repository 140, and developer computer system 150 as separate computing systems located at different nodes on network 160, the operations of one of these computing systems can be performed by another without departing from the spirit and scope of the disclosed embodiments. For example, in some embodiments, the operations of source code analyzer 110 and source code repairer 120 may be performed by one physical or logical computing system. As another example, training source code repository 130 and deployment source code repository 140 can be the same physical or logical computing system in some embodiments. Also, the operations performed by source code analyzer 110 and source code repairer 120 can be performed by developer computer system 150 in some embodiments. Thus, the logical and physical separation of operations among the computing systems depicted in FIG. 1 is for the purpose of simplifying the present disclosure and is not intended to limit the scope of any claims arising from it.

### Source Code Analyzer

According to some embodiments, system 100 includes source code analyzer 110. Source code analyzer 110 can be a computing system that analyzes training source code to train a model, using a deep learning architecture, for detecting defects in a software project's source code. As shown in FIG. 1, source code analyzer 110 can contain multiple modules and/or components for performing its operations, and these modules and/or components can fall into two categories—those used for training the deep learning model and those used for applying that model to source code from a development project.

According to some embodiments, source code analyzer 110 may train a model using first source code that is within a context to detect defects in second source code that is within that same context. A context can include, but is not limited to, a programming language, a programming environment, an organization, an end use application, or a combination of these. For example, the first source code (used for training the model) may be written in C++ and for a missile defense system. Using the first source code, source code analyzer 110 may train a neural network to detect defects within second source code that is written in C++ and is for a satellite system. As another non-limiting example, an organization may use first source code written in Java for a user application to train a neural network to detect defects within second source code written in Java for the user application.

In some embodiments, source code analyzer 110 includes training data collector 111, training control flow extractor 112, training statement encoder 113, and classifier 114 for training the deep learning model. These modules of source code analyzer 110 can communicate data between each other according to known data communication techniques and, in some embodiments, can communicate with external computing systems such as training source code repository 130 and deployment source code repository 140.

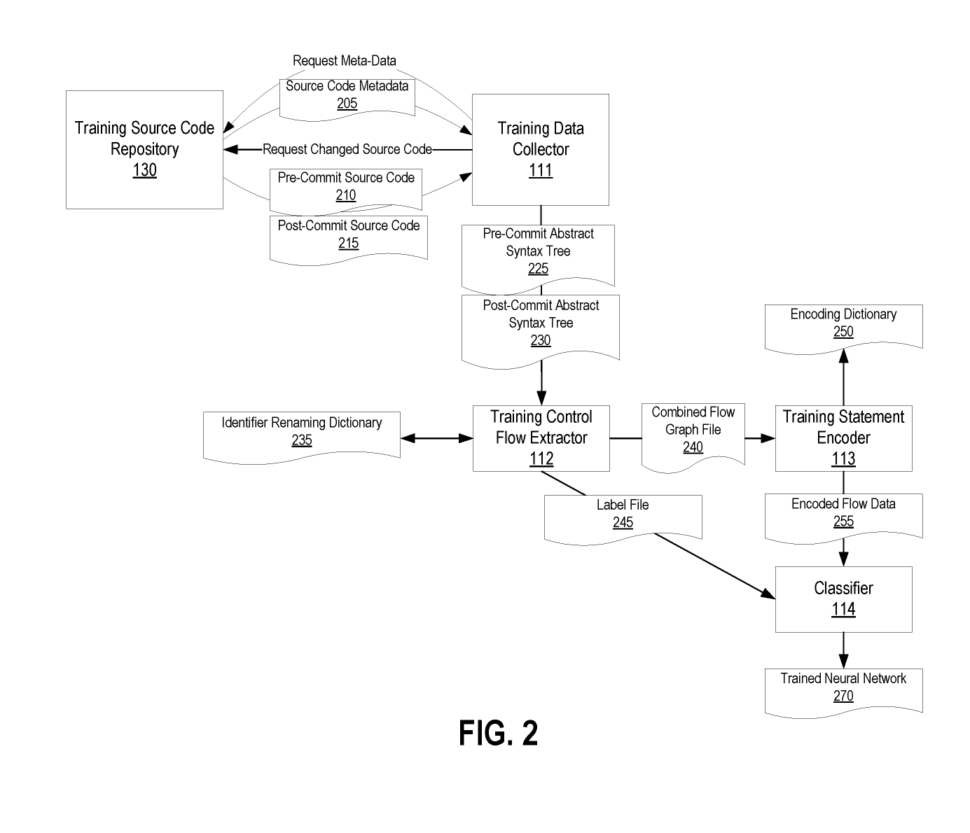

FIG. 2 shows a data and process flow diagram depicting the data transferred to and from training data collector 111, training control flow extractor 112, training statement encoder 113, and classifier 114 according to some embodiments.

In some embodiments, training data collector 111 can perform operations for obtaining source code used by source code analyzer 110 to train a model for detecting defects in source code according to a deep learning architecture. As shown in FIG. 2, training data collector 111 interfaces with training source code repository 130 to obtain source code metadata 205 describing source code stored in training source code repository 130. Training data collector 111 can, for example, access an API exposed by training source code repository 130 to request source code metadata 205. Source code metadata 205 can describe, for a given source code project, repaired defects to the source code and the nature of those defects. For example, a source code project written in the C programing language typically has one or more defects related to resource leaks. Source code metadata 205 can include information identifying those defects related to resource leaks and the locations (e.g., file and line number) of the repairs made to the source code by developers to address the resource leaks. Once the training data collector 111 obtains source code metadata 205, it can store it in a database for later access, periodic downloading of source code, reporting, or data analysis purposes. Training data collector 111 can access source code metadata 205 on a periodic basis or on demand.

Using source code metadata 205, training data collector 111 can prepare requests to obtain source code files containing fixed defects. According to some embodiments, the training data collector 111 can request the source code file containing the defect—pre-commit source code 210—and the same source code file after the commit that fixed the defect—post-commit source code 215. By obtaining source code metadata 205 first and then obtaining pre-commit source code 210 and post-commit source code 215 based on the content of source code metadata 205, training data collector 111 can minimize the volume of source code it analyzes to improve its operational efficiency and decrease load on the network from multiple, unneeded requests (e.g., for source code that has not changed). But, in some embodiments, training data collector 111 can obtain the entire source code base for a given project, without selecting individual source code files based on source code metadata 205, or obtain source code without obtaining source code metadata 205 at all.

According to some embodiments, training data collector 111 can also prepare source code for analysis by the other modules and/or components of source code analyzer 110. For example, training data collector 111 can perform operations for parsing pre-commit source code 210 and post-commit source code 215 to create pre-commit abstract syntax tree 225 and post-commit abstract syntax tree 230, respectively. Training data collector 111 can create these abstract syntax trees (“ASTs”) so that training control flow extractor 112 can easily consume and interpret pre-commit source code 210 and post-commit source code 215. Pre-commit abstract syntax tree 225 and post-commit abstract syntax tree 230 can be stored in a data structure, object, or file, depending on the embodiment.

As shown in FIG. 1, source code analyzer 110 can also include training control flow extractor 112. Training control flow extractor 112 accepts source code data from training data collector 111 and generates control flow graphs (“CFGs”) for the accepted source code data. As illustrated in FIG. 2, the source code data can include pre-commit abstract syntax tree 225 and post-commit abstract syntax tree 230, which correspond to pre-commit source code 210 and post-commit source code 215. According to some embodiments, before training control flow extractor 112 creates the CFGs, it refactors and renames variables in pre-commit abstract syntax tree 225 and post-commit abstract syntax tree 230 to normalize it. Normalizing allows training control flow extractor 112 to recognize similar code that primarily differs only with respect to the arbitrary variable names given to it by developers. In some embodiments, training control flow extractor 112 uses shared identifier renaming dictionary 235 for refactoring the code. Identifier renaming dictionary 235 is a data structure mapping variables in pre-commit abstract syntax tree 225 and post-commit abstract syntax tree 230 to normalized variable names used across source code data sets.

In some embodiments, training control flow extractor 112 creates CFGs for the pre-commit and post-commit source code once the ASTs have been refactored yielding a pre-commit CFG and a post-commit CFG. Training control flow extractor 112 can then traverse the pre-commit CFG and the post-commit CFG using a depth-first search to compare their flows. When training control flow extractor 112 identifies differences between the pre-commit CFG and the post-commit CFG, it flags the different flow as a potential defect and stores it in a data structure or test file representing “bad” control flows. Similarly, when training control flow extractor 112 identifies similarities between the pre-commit CFG and the post-commit CFG, it flags the flow as potentially defect-free and stores it in a data structure or text file representing “good” control flows. Training control flow extractor 112 continues traversing both the pre-commit and the post-commit CFGs, while appending good and bad flows to the appropriate file or data structure, until it reaches the end of the pre-commit and the post-commit CFGs.

According to some embodiments, after training control flow extractor 112 completes traversal of the pre-commit CFG and the post-commit CFG, it will have created a list of bad control flows and good control flows, each of which are stored separately in a data structure or file. Then, as shown in FIG. 2, training control flow extractor 112 creates combined control flow graph file 240 that will later be used for training the deep learning defect detection model. To create combined control flow graph file 240, training control flow extractor 112 randomly selects bad flows and good flows from their corresponding file. In some embodiments, training control flow extractor 112 selects an uneven ratio of bad flows and good flows. For example, training control flow extractor 112 may select one bad flow for every nine good flows, to create a selection ratio of 10% bad flows for combined control flow graph file 240. While the ratio of bad flows may vary across embodiments, one preferable ratio is 25% bad flows in combined control flow graph file 240.

As also illustrated in FIG. 2, training control flow extractor 112 creates label file 245. Label file 245 stores an indicator describing whether the flows in combined control flow graph file 240 are defect-free (e.g., a good flow) or contain a potential defect (e.g., a bad flow). Label file 245 and combined control flow graph file 240 may correspond on a line number basis. For example, the first line of label file 245 can include a good or bad indicator (e.g., a “0” for good, and a “1” for bad) corresponding to the first line of combined control flow graph file 240, the second line of label file 245 can include a good or bad indicator corresponding to the second line of combined control flow graph file 240, and so on.

Returning to FIG. 1, source code analyzer 110 can also include training statement encoder 113. Training statement encoder 113 performs operations converting the flows from combined control flow graph file 240 into a format that can be used as inputs to train the deep learning model of classifier 114. In some embodiments, a vector representation of the statements in the flows is used, while in other embodiments an index value (e.g., an integer value) that is converted by an embedding layer (discussed in more detail below) to a vector can be used. To limit the dimensionality of the vectors used by classifier 114 to train the deep learning model, training statement encoder 113 does not encode every unique statement within combined control flow graph file 240; rather, it encodes the most common statements. To do so, training statement encoder 113 creates a histogram of the unique statements in combined control flow graph file 240. Using the histogram, training statement encoder 113 identifies the most common unique statements and selects those for encoding. For example, training statement encoder 113 may use the top 1000 most common statements in combined control flow graph file 240. The number of unique statements that training statement encoder 113 uses can vary from embodiment to embodiment, and can be altered to improve the efficiency and efficacy of defect detection depending on the domain of the source code undergoing analysis.

Once the most unique statements are identified, training statement encoder 113 creates encoding dictionary 250 as shown in FIG. 2. Training statement encoder 113 uses encoding dictionary 250 to encode the statements in combined control flow graph file 240. According to one embodiment, training statement encoder creates encoding dictionary 250 using a “one-of-k” vector encoding scheme, which is also referred to as a “one-hot” encoding scheme in the art. In a one-of-k encoding scheme, each unique statement is represented with a vector including a total number of elements equaling the number of unique statements being encoded, wherein one of the elements is set to a one-value (or “hot”) and the remaining elements are set to zero-value. For example, when training statement encoder 113 vectorizes 1000 unique statements, each unique statement is represented by a vector of 1000 elements, one of the 1000 elements is set to 1, and the remainder are set to zero. The encoding dictionary maps the one-of-k encoded vector to the unique statement. While training statement encoder 113 uses one-of-k encoding according to one embodiment, training statement encoder 113 can use other vector encoding methods. In some embodiments, training statement encoder 113 encodes statements by mapping statements to an index value. The index value can later be assigned to a vector of floating point values that can be adjusted when classifier 114 trains trained neural network 270.

As shown in FIG. 2, once training statement encoder 113 creates encoding dictionary 250, it processes combined control flow graph file 240 to encode it and create encoded flow data 255. For each statement in each flow in combined control flow graph file 240, training statement encoder 113 replaces the statement with its encoded translation from encoding dictionary 250. For example, training statement encoder 113 can replace the statement with its vector representation for encoding dictionary 250, or index representation, as appropriate for the embodiment. For statements that are not included in encoding dictionary 250, training statement encoder 113 replaces the statement with a special value representing an unknown statement, which can be an all-one or all-zero vector, or an specific index value (e.g., 0), depending on the embodiment.

Returning to FIG. 1, source code analyzer also contains classifier 114. Classifier 114 uses deep learning analysis techniques to create a trained neural network that can be used to detect defects in source code. As shown in FIG. 2, classifier 114 uses encoded flow data 255 created by training statement encoder 113 and label file 245 to create trained neural network 270. To determine the weights of the synapses in trained neural network 270, classifier 114 uses each row of encoded flow data 255 (representing a flow) as input and its associated label (representing a defect or non-defect) as output. Classifier 114 iterates through all flows and tunes the weights as needed to arrive at the output for each data row. According to some embodiments, classifier 114 can also tune the floating point values of vectors used by the embedding layer in addition to, or in lieu or, tuning the weights of synapses. According to some embodiments, classifier 114 uses a recurrent neural network model, but classifier 114 can also use a deep feedforward or other neural network models. Classifier 114 continues computation until it considers all of encoded flow data 255. In addition, classifier 114 can continue to tune trained neural network 270 over several sets of pre-commit and post-commit source code data sets. In such cases, identifier renaming dictionary and encoding dictionary may be reused over several sets of source code data.

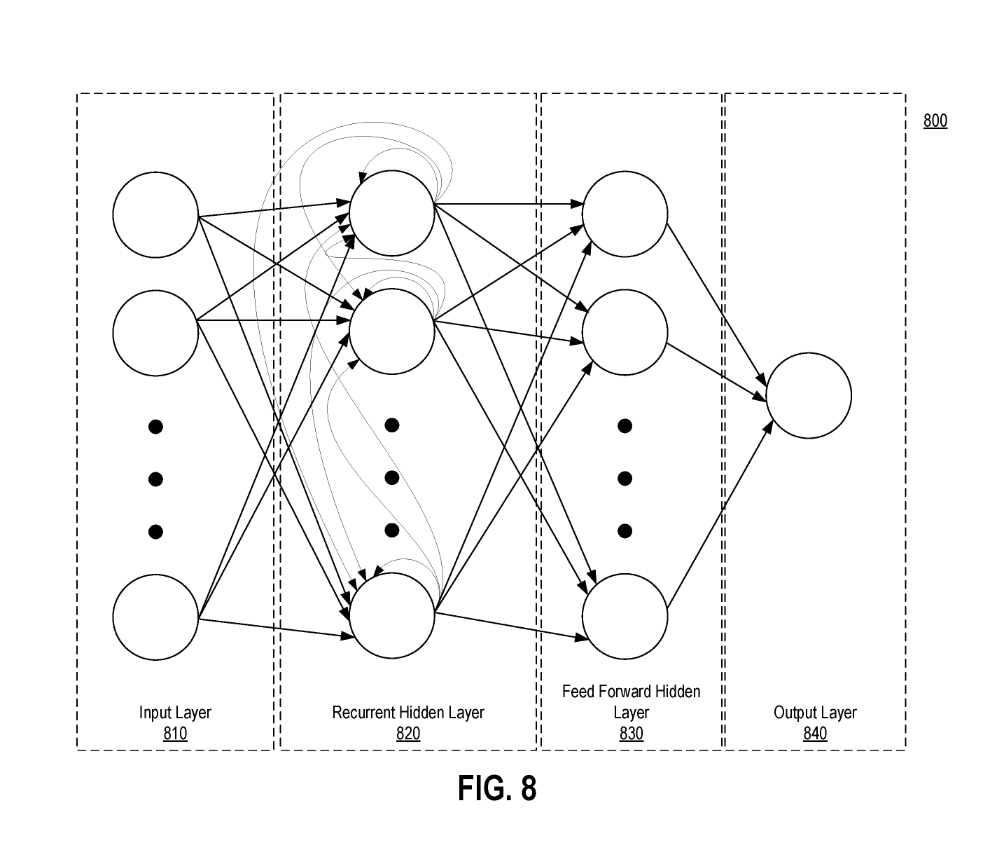

In some embodiments, classifier 114 employs recurrent neural network architecture 800, shown in FIG. 8. Recurrent neural network architecture 800 includes four layers, input layer 810, recurrent hidden layer 820, feed forward layer 830, and output layer 840. Recurrent neural network architecture 800 is fully connected for input layer 810, recurrent hidden layer 820, and feed forward layer 830. Recurrent hidden layer 820 is also fully connected with itself. In this manner, as classifier 114 trains trained neural network 270 over a series of time steps, the output of recurrent hidden layer 820 for time step t is applied to the neurons of recurrent hidden layer 820 for time step t+1.

While FIG. 8 illustrates input layer 810 including three neurons, the number of neurons is variable, as indicated by the “. . . ” between the second and third neurons of input layer 810 shown in FIG. 8. According to some embodiments, the number of neurons in input layer 810 corresponds to the dimensionality of the vectors in encoding dictionary 250, which also corresponds to the number of statements in encoding dictionary 250 (including the unknown statement vector). For example, when encoding dictionary 250 includes encoding for 1,024 statements, each vector has 1,024 elements (using one-of-k encoding) and input layer 810 has 1,024 neurons. Also, recurrent hidden layer 820 and feed forward layer 830 include the same number of neurons as input layer 810. Output layer 840 includes one neuron, in some embodiments.

In some embodiments, input layer 810 includes an embedding layer, similar to the one described in T. Mikolov et al., “Distributed Representations of Words and Phrases and their Compositionality,” Proceedings of NIPS (2013), which is incorporated by reference in its entirety (available at http://papers.nips.cc/paper/5021-distributed-representations-of-words-and-phrases-and-their-compositionality.pdf). In such embodiments, input layer 810 assigns a vector of floating point values for an index corresponding with a statement in encoded flow data 255. At initialization, the floating point values in the vectors are randomly assigned. During training, the values of the vectors can be adjusted. By using an embedding layer, significantly more statements can be encoded for a given vector dimensionality than in an one-of-k encoding scheme. For example, for a 256-dimension vector, 256 statements (including the unknown statement vector) can be represented using one-k-encoding, but using an embedding layer can result in tens of thousands of statement representations. Also, recurrent hidden layer 820 and feed forward layer 830 include the same number of neurons as input layer 810. Output layer 840 includes one neuron, in some embodiments. In embodiments employing an embedding layer, the number or neurons in recurrent hidden layer 820 and feed forward layer 830 can be equal to the number of neurons in input layer 810.

According to some embodiments, the activation function for the neurons of recurrent neural network architecture 800 can be TanH or Sigmoid. Recurrent neural network architecture 800 can also include a cost function, which in some embodiments, is a binary cross entropy function. Recurrent neural network architecture 800 can also use an optimizer, which can include, but is not limited to, an Adam optimizer in some embodiments (see, e.g., D. Kingma and J. Ba, “Adam: A Method for Stochastic Optimization,” 3rd International Conference for Learning Representations, San Diego, 2015, incorporated by reference herein in its entirety). In some embodiments, recurrent neural network architecture 800 uses a method called dropout to reduce overfitting of trained neural network 270 due to sampling noise within training data (see, e.g., N. Srivastava et al., “Dropout: A Simple Way to Prevent Neural Networks From Overfitting,” Journal of Machine Learning Research, Vol. 15, pp. 1929-1958, 2014, incorporated by reference herein in its entirety). For recurrent neural network architecture 800, a dropout value of 0.4 can be applied between recurrent hidden layer 820 and feed forward layer 830 to reduce overfitting.

Although some embodiments of classifier 114 use recurrent neural network architecture 800 with the parameters described above, classifier 114 can use different neural network architectures without departing from the spirit and scope of the present disclosure. In addition, classifier 114 can use different architectures for different types of defects, and in some embodiments, the neuron activation function, the cost function, the optimizer, and/or the dropout can be tuned to improve performance for a particular defect type.

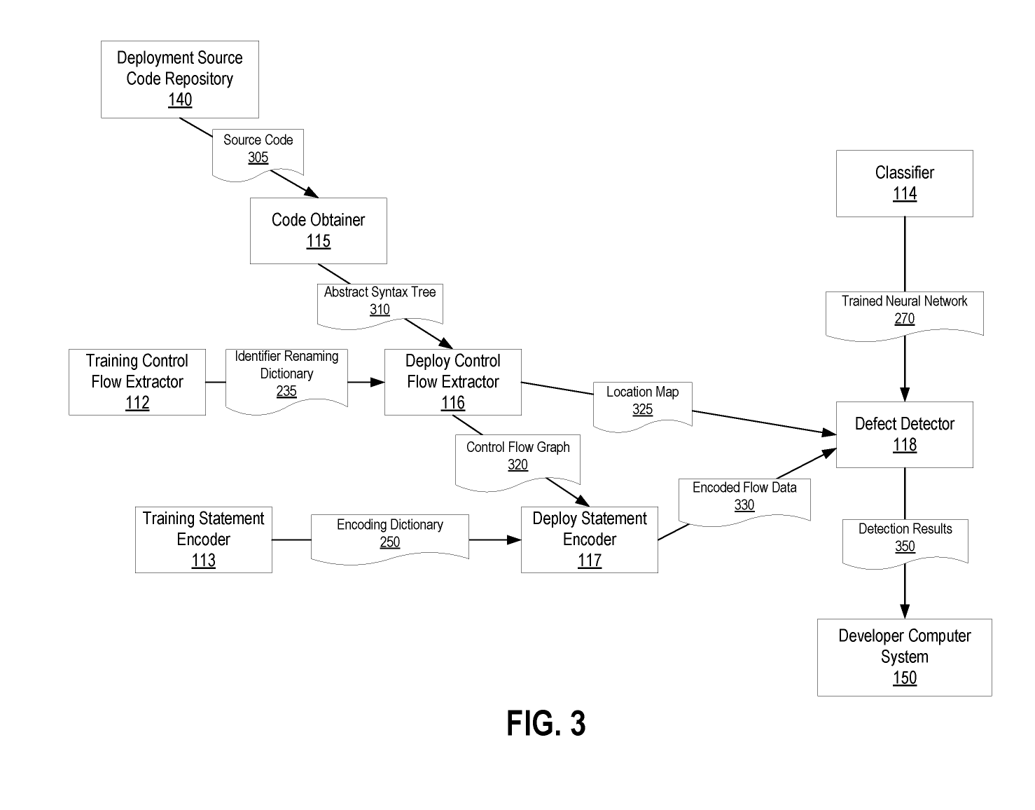

Returning to FIG. 1, according to some embodiments, source code analyzer 110 can also contain code obtainer 115, deploy control flow extractor 116, deploy statement encoder 117 and defect detector 118, which are modules and/or components for applying trained neural network 270 to source code that is undergoing V&V. These modules of source code analyzer 110 can communicate data between each other according to known data communication techniques and, in some embodiments, can communicate with external computing systems such as deployment source code repository 140. FIG. 3 shows a data and process flow diagram depicting the data transferred to and from code obtainer 115, deploy control flow extractor 116, deploy statement encoder 117 and defect detector 118 according to some embodiments.

Source code analyzer 110 can include code obtainer 115. Code obtainer 115 performs operations to obtain source code analyzed by source code analyzer 110. As shown in FIG. 3, code obtainer 115 can obtain source code 305 from deployment source code repository 140. Source code 305 is source code that is part of a software development project for which V&V processes are being performed. Deployment source code repository 140 can provide source code 305 to code obtainer 115 via an API, file transfer protocol, or any other source code delivery mechanism known within the art. Code obtainer 115 can obtain source code 305 on a periodic basis, such as every week, or on an event basis, such as after a successful build of source code 305. In some embodiments, code obtainer 115 can interface with an integrated development environment executing on developer computer system 150 so developers can specify which source code files stored in deployment source code repository 140 code obtainer 115 gets.

According to some embodiments, code obtainer 115 creates an AST for source code 305, represented as abstract syntax tree 310 in FIG. 3. Once code obtainer 115 creates AST 310, it provides AST 310 to deploy control flow extractor 116.

In some embodiments, source code analyzer 110 includes deploy control flow extractor 116. Deploy control flow extractor 116 performs operations to generate a control flow graph (CFG) for AST 310, which is represented as control flow graph 320 in FIG. 3. Before creating control flow graph 320, deploy control flow extractor 116 can refactor and rename AST 310. The refactor and rename process performed by deploy control flow extractor 116 is similar to the refactor and rename process described above with respect to training control flow extractor 112, which is done to normalize pre-commit AST 225 and post-commit AST 230. According to some embodiments, deploy control flow extractor 116 normalizes AST 310 using identifier renaming dictionary 235 produced by training control flow extractor 112. Deploy control flow extractor 116 uses identifier renaming dictionary 235 so that AST 310 is normalized in the same manner as pre-commit AST 225 and post-commit AST 230. Once deploy control flow extractor 116 refactors AST 310 it creates control flow graph 320 which will later be used by deploy statement encoder 117.

Deploy control flow extractor 116 can also create location map 325. Location map 325 can be a data structure or file that maps flows in control flow graph 320 to locations within source code 305. Location map 325 can be a data structure implementing a dictionary, hashmap, or similar design pattern. As shown in FIG. 3, location map 325 can be used by defect detector 118. When defect detector 118 identifies a defect, it does so using an abstraction of source code 305. To link the abstraction of source code 305 back to a location within source code 305, defect detector 118 references location map 325 so that developers are aware of the location of the defect within source code 305.

According to some embodiments, source code analyzer 110 can also include deploy statement encoder 117. Deploy statement encoder 117 performs operations to encode control flow graph 320 so control flow graph 320 is in a format that can be input to trained neural network 270 to identify defects. Deploy statement encoder 117 creates encoded flow data 330, an encoded representation of the flows within control flow graph 320, by traversing control flow graph 320 and replacing each statement for each flow with its corresponding representation as defined in encoding dictionary 250. As explained above, training statement encoder 113 creates encoding dictionary 250 when source code analyzer 110 develops trained neural network 270.

Source code analyzer 110 can also include defect detector 118. Defect detector 118 uses trained neural network 270 as developed by classifier 114 to identify defects in source code 305. As shown in FIG. 3, defect detector 118 accesses trained neural network 270 from classifier 114 and receives encoded flow data 330 from deploy statement encoder 117. Defect detector 118 then feeds as input to trained neural network 270 each flow in encoded flow data 330 and determines whether the flows contain a defect, according to trained neural network 270. When the output of trained neural network 270 indicates a defect is present, defect detector 118 appends the defect result to detection results 350, which is a file or data structure containing the defects for the data set. Also, for each defect detected, defect detector 118 accesses location map 325 to lookup the location of the defect. The location of the defect is also stored to detection results 350, according to some embodiments.

Once defect detector 118 analyzes encoded flow data 330, detection results 350 are provided to developer computer system 150. Detection results 350 can be provided as text file, XML, file, serialized object, via a remote procedure call, or by any other method known in the art to communicate data between computing systems. In some embodiments, detection results 350 are provided as a user interface. For example, defect detector 118 can generate a user interface or a web page with contents of detection results 350, and developer computer system 150 can have a client program such as a web browser or client user interface application configured to display the results.

In some embodiments, detection results 350 are formatted to be consumed by an IDE plug-in residing on developer computer system 150. In such embodiments, the IDE executing on developer computer system 150 may highlight the detected defect within the source code editor of the IDE to notify the user of developer computer system 150 of the defect.

### Source Code Repairer

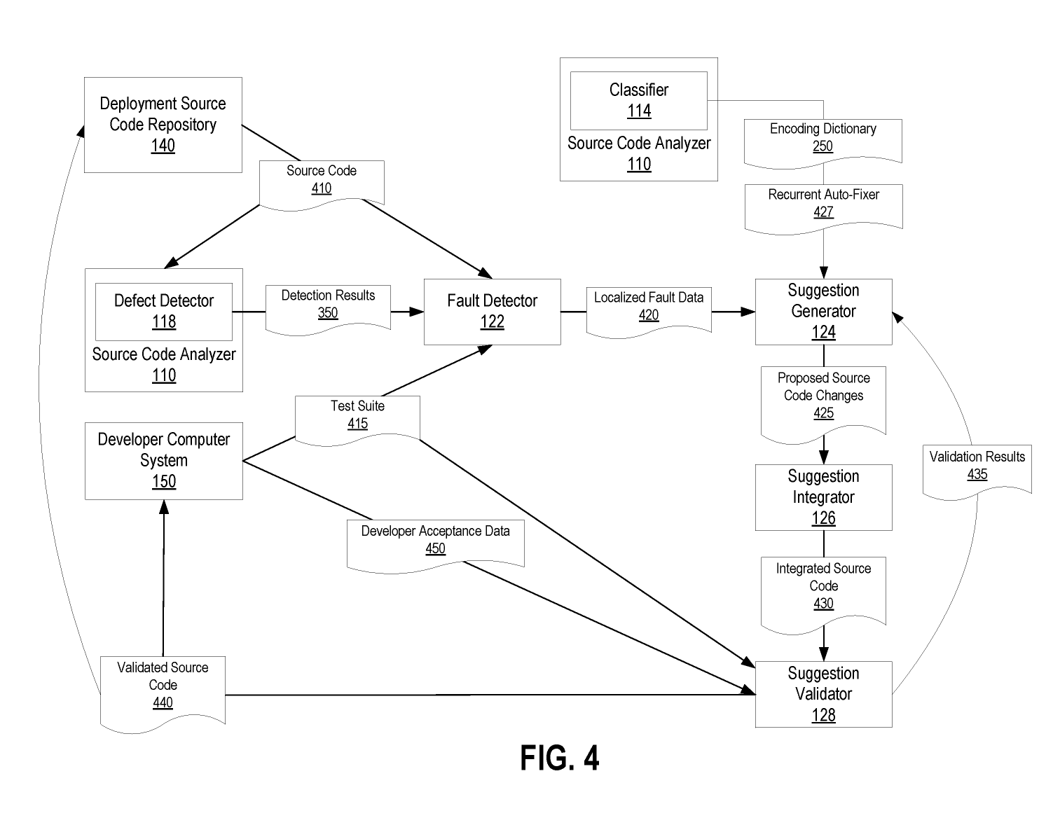

With reference back to FIG. 1, according to some embodiments, system 100 includes source code repairer 120. Source code repairer 120 can be a computing system that detects defects within source code and repairs those defects by replacing defective code with source code anticipated to address the defect. In some embodiments, and as described in greater detail below, source code repairer 120 can automatically repair source code, that is, source code may be replaced without developer intervention. In some embodiments, source code repairer 120 provides one or more source code repair suggestions to a developer via developer computer system 150, and developers may choose one of the suggestions to use as a repair. In such embodiments, the developer computer system 150 communicate the selected suggestion back to source code repairer 120, and source code repairer 120 can integrate the selection into the source code base. As shown in FIG. 1, source code repairer 120 can contain multiple modules and/or components for performing its operations. FIG. 4 illustrates the data and process flow between the multiple modules of source code repairer 120, and in some embodiments, the data and process flow between modules of source code repairer 120 and other computing systems in system 100.

According to some embodiments, source code repairer 120 can include fault detector 122. Fault detector 122 performs operations to detect defects in source code 410 or identify one or more lines of source code in source code 410 suspected of containing a defect. Fault detector 122 can perform its operations using one or more methods of defect detection. For example, fault detector 122 can detect defects in source code 410 using the operations performed by source code analyzer 110 described above. As shown in FIG. 4, according to some embodiments, once defect detector 118 of source code analyzer 110 generates detection results 350 for source code 410, it can communicate detection results 350 to fault detector 122. Detection results 350 can include, for example, the location of the defect, the type of defect, and the source code generating the defect, which can include the source code text or an AST of the defect and the code surrounding the defect. Once fault detector 122 obtains detection results 350, it can generate localized fault data 420 for suggestion generator 124.

In some embodiments, fault detector 122 uses test suite 415 to identify suspicious lines of code that may contain defects. Test suite 415 contains a series of test cases that are run against an executable form of source code 410. Fault detector 122 can create a matrix mapping lines of code in source code 410 with the test cases of test suite 415. When a test case executes a line of code, fault detector 122 can record whether the line of code passes or fails according to the test case. Once fault detector 122 executes test suite 415 against source code 410, it can analyze and process the matrix to locate which lines of code in source code 410 are suspected of causing the defect and generates localized fault data 420. Localized fault data 420 can include the lines of code suspected of containing a defect, the code before and after the defect, and/or an abstraction of the defect or source code 410, such as an AST or CFG of the source code.

In some embodiments, fault detector 122 uses both test suite 415 and detection results 350 generated by source code analyzer 110 to locate defects in source code 410. Using both of these methods can be advantageous when the types of defects detectable using source code analyzer 110 are different than the types of defects that might be detectable using test suite 415, which may be the case in some embodiments. Fault detector 122 can also use static code analysis techniques known in the art such as pattern matching in addition to or in lieu of test suite 415 and detection results 350.

As shown in FIG. 1, source code repairer 120 can also include suggestion generator 124. Suggestion generator 124, according to some embodiments, performs operations to generate one or more fixes or patches to remedy the defect detected by fault detector 122. Suggestion generator 124 can employ one or more methods for suggesting fixes or patches to source code 410.

In some embodiments, suggestion generator 124 uses genetic programming techniques to make source code repair suggestions. Using a genetic programming technique, suggestion generator 124 can create an AST of the defect and the code surrounding the defect, if the AST was not already created. Suggestion generator 124 will then perform operations on the AST at a node corresponding to the defect, such as removing the node, repositioning the node within the AST, or replacing the node entirely. In some embodiments, the replacement node may be selected at random from some other portion of the AST, or the replacement node may be selected at random from an AST formed from all of source code 410. In some embodiments, suggestion generator 124 can also modify the AST for the defect by wrapping the defective node, and/or nodes one or two nodes aware in the AST from the defective node, with a conditional node (e.g., a node corresponding to an if statement in code) that prevents execution of the defective node unless some condition is met. Suggestion generator 124 translates the modification made to the AST into proposed source code changes 425, which can be a script for modifying source code 410 in some embodiments.

According to some embodiments, a recurrent neural network can be trained to suggest a repair to a source code defect. As shown in FIG. 4, suggestion generator 124 can use recurrent auto-fixer 427 to generate fix suggestions. Recurrent auto-fixer 427 can be a recurrent neural network trained using training data representing defects identified by developers and the code used by those developers to fix the defect. In this manner, recurrent auto-fixer 427 offers sequence-to-sequence mapping between a detected defect and code that can be used to fix it.

Recurrent auto-fixer 427 can be trained using a process similar to the process described in FIG. 2 with respect to training trained neural network 270 to identify defects in source code. For example, in some embodiments, source code analyzer 110 obtains code containing known defects (similar to pre-commit source code 210) and developer fixes for those defects (similar to post-commit source code 215). The defective code and the fixes for the defective code can be encoded, and classifier 114 trains a recurrent neural network using encoded control flows for the defective code as inputs to the network and encoded control flows for the fixes as expected outputs to the networks. After network is sufficiently trained, source code analyzer 110 can provide recurrent auto-fixer 427 and encoding dictionary 250 to suggestion generator 124. Then, suggestion generator 124 can encode the source code for the defect using encoding dictionary 250 and provide the encoded defect to recurrent auto-fixer 427. The output of recurrent auto-fixer's 427 recurrent neural network is a sequence of vectors that when decoded using encoding dictionary 250 provides a suggested repair to the defect.

While FIG. 4 shows source code analyzer 110 providing recurrent auto-fixer 427 to suggestion generator 124, in some embodiments, modules of source code repairer 120 generate recurrent auto-fixer 427. In such embodiments, source code repairer 120 can include modules or components performing operations similar to training data collector 111, training control flow extractor 112, training statement encoder 113 and classifier 114 to train recurrent auto-fixer 427. Also, while FIG. 4 and the above disclosure refers to recurrent auto-fixer 427 as containing one trained recurrent neural network, in some embodiments, recurrent auto-fixer includes a plurality of trained recurrent neural networks where the members of the plurality correspond to a defect type. For example, recurrent auto-fixer 427 can include a first trained recurrent neural network for suggesting changes to address null pointer defects, a second trained recurrent neural network for suggesting changes to address off-by-one errors, a third trained recurrent neural network for suggesting changes to address infinite loops or recursion, etc.

In some embodiments, recurrent auto-fixer 427 can be trained using defect free code for a particular type to leverage the probabilistic nature of artificial neural networks. When recurrent auto-fixer 427 is trained to recognize defect free source code for a particular defect, it will likely recognize defective code as anomalous. As a result, given defective code as input, the output will likely be a “normalized” version of the defect—defect free code that is similar in structure to the defective code, yet without the defect. In such embodiments, the training data for recurrent auto-fixer 427 consists of a set of encoded control flows abstracting source code related to a particular defect type, but where each of the control flows are different. The network is trained by applying each encoded control flow to the input of the network. The network then creates an output which is reapplied as input to the network, with the goal of recreating the original encoded control flow provided as input during the beginning of the training cycle. The process is then applied to the recurrent neural network for each encoded control flow for the defect type, resulting in a trained recurrent network that outputs defect free code when defect free code is applied to it. Once recurrent auto-fixer 427 is trained in this manner, suggestion generator 124 can input the defect, in encoded form, to recurrent auto-fixer 427. While the code contains a defect at input, the recurrent auto-fixer has been trained to normalize the code, which can result in “normalizing out” the defect. The resulting output is an encoded version of a source code fix for the defective input code. Suggestion generator 124 can decode the output to a source code statement, which can be included in proposed source code changes 425.

In some embodiments, suggestion generator 124 can use more than one method of suggesting a code change to address the defect. In such embodiments, suggestion generator 124 may use one method to create a set of suggestions that are vetted by the second method. For example, in one embodiment, suggestion generator 124 can generate possible suggestions to remedy defects in source code using the generic programming techniques discussed above. Then, suggestion generator 124 can vet each of those suggestions using recurrent auto-fixer 427 to reduce the number of possible suggestions passed to suggestion integrator 126 and suggestion validator 128. Vetting suggestions reduces the number of source code suggestions validated by suggestion validator 128, which can provide efficiency advantages because validating source code using test suite 415 can be computationally expensive.

In some embodiments, source code repairer 120 includes suggestion integrator 126, as shown in FIG. 1. Suggestion integrator 126 performs operations to integrate proposed source code changes 425 into the source code, which is shown in FIG. 4. According to some embodiments, proposed source code changes 425 can include one or more scripts that search for defective lines of code and replaces them with lines of code suggested by suggestion generator 124. Suggestion integrator 126 can include a script interpretation engine that can read and execute the script contained in proposed source code changes 425 to create integrated source code 430.

Source code repairer 120 can include suggestion validator 128 according to some embodiments. Suggestion validator 128 performs one or more operations for validating the integrated source code 430 to ensure that the suggested repairs for the defects identified in source code 410 repair the defects and do not introduce new defects into integrated source code 430. According to some embodiments, suggestion validator 128 performs similar operations as fault detector 122, as described above. If the same or new defects are detected in integrated source code 430, suggestion validator 128 sends validation results 435 to suggestion generator 124, and suggestion generator 124 can generate different source code suggestions to remedy the defects. The process may repeat until integrated source code 430 is free of defects, or after a set number of iterations (to avoid potential infinite loops). When suggestion validator 128 determines integrated source code 430 is free of defects, it sends validated source code 440 to deployment source code repository 140. According to some embodiments, suggestion validator 128 does not send validated source code 440 to deployment source code repository 140 until it has been accepted by a developer, as described below.

In some embodiments, suggestion validator 128 sends validated source code 440 to developer computer system 150 for acceptance by developers. When developer computer system 150 receives validated source code 440, it may display it for acceptance by a developer. Developer computer system 150 can also display one or more user interface elements that the developer can use to accept validated source code. For example, developer computer system 150 can display validated source code 440 in an IDE, highlight the changes in code, and provide a graphical display displaying the code found to be defective.

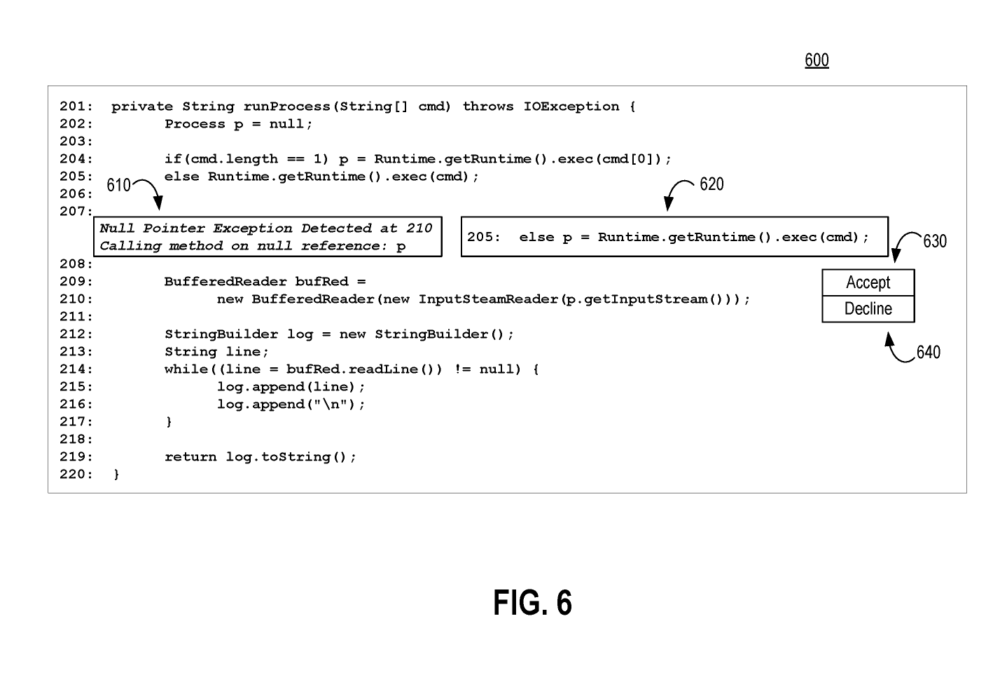

In some embodiments, developers are given the option to accept or decline validated source code 440, as part of an interactive source code repair process. In such embodiments, developer computer system 150 can display one or more selectable user interface elements allowing the developer to accept or decline the suggestion. An example of such selectable user interface elements is provided in FIG. 6. When the developer selects to either accept or decline validated source code 440, developer computer system 150 can communicate developer acceptance data 450 to suggestion validator 128. If developer acceptance data 450 indicates the developer rejected the change, suggestion validator can provide another set of validated source code 440 to developer computer system 150. Suggestion validator 128 can also communicate the developer acceptance data 450 to suggestion generator 124 via validation results 435. When validation results 435 indicates a suggestion rejection by a developer, suggestion generator 124 can generate an alternative suggestion consistent with the present disclosure.

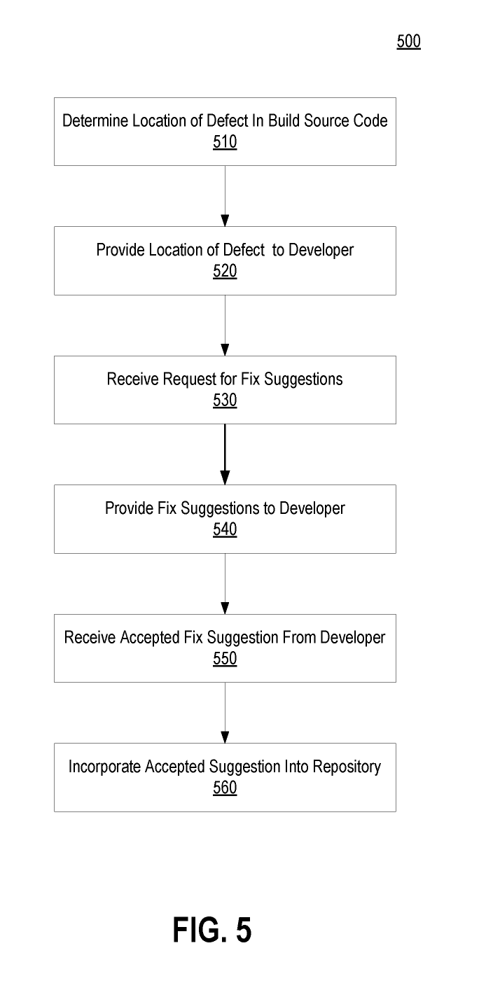

FIG. 5 is a flowchart representation of an interactive source code repair process 500 performed by source code repairer 120 according to some embodiments. Source code repair process 500 starts at step 510, source code repairer 120 detects defects with source code undergoing V&V. In some embodiments, source code repairer 120 detects defects using source code analyzer 110, or by performing operations performed by source code analyzer 110 described herein. In some embodiments, source code repairer 120 detects the location of defects in the source code using the test case defect localization methods described above with respect to FIG. 4.

After defects within the source code are located, source code repairer 120 provides the location and identity of the defects to developer computer system 150 at step 520. In some embodiments, source code repairer 120 communicates the source code line number for the defect and/or the type of defect, and developer computer system 150 executes an application that uses the provided information to generate a user interface to display the defect (for example, the user interface of FIG. 6). In some embodiments, source code repairer 120 generates code that when executed (e.g., by an application executed by developer computer system 150) provides a user interface that describes the location and nature of the defect. For example, source code repairer 120 can generate an HTML document showing the location and nature of the defect which can be rendered in a web browser executing on developer computer system 150.

According to some embodiments, at step 530, source code repairer 120 can receive a request for fix suggestions to an identified defect. In some embodiments, the request for fix suggestions can come from a developer selecting a user interface element displayed by developer computer system 150 that is part of an IDE plug-in that communicates with source code repairer 120. Once the request is received, source code repairer 120 can generate one or more suggestions to fix the defective source code. Source code repairer 120 may generate the suggestions using one of the methods and techniques described above with respect to FIG. 4.

When source code repairer 120 has determined suggested fixes, it can communicate the suggestions to developer computer system 150 at step 540. In some embodiments, source code repairer 120 provides many of the determined suggestions at one time, and developer computer system 150 may display them in a user interface element allowing the developer to select one of the suggested fixes. In some embodiments, source code repairer 120 provides suggested fixes one at a time. In such embodiments, source code repairer 120 may loop through steps 530 and 540 until it receives an accepted fix suggestion at step 550.

At step 550, source code repairer 120 receives the accepted suggestion from developer computer system 150 and incorporates the accepted source code suggestion into the source code repository. According to some embodiments, source code repairer 120 may attempt a build of the source code repository before committing the suggestion to the repository to ensure that the suggestion is syntactically correct. In some embodiments, source code repairer 120 may attempt to analyze the source code again for defects once the suggestion has been incorporated, but before committing the suggestion to the repository, as a means of regression testing the suggestion. Source code repairer 120 may perform this operation to ensure that the suggested code fix does not introduce additional defects into the source code base upon a commit.

### User Interface Examples for Some Embodiments

FIG. 6 illustrates an example user interface that can be generated by source code repairer 120 consistent with embodiments of the present disclosure. For example, the user interface described in FIG. 6 can be generated by suggestion integrator 126 and/or suggestion validator 128. The example user interface of FIG. 6 is meant to help illustrate and describe certain features of disclosed embodiments, and is not meant to limit the scope of the user interfaces that can be generated or provided by source code repairer 120. Furthermore, although the following disclosure describes that source code repairer 120 generates the user interface of FIG. 6, in some embodiments, other computing systems of system 100 (e.g., source code analyzer 110) may generate it. In addition, while the present disclosure describes user interface of FIG. 6 as being generated by source code repairer 120, the verb generate in the context of this disclosure includes, but is not limited to, generating the code or data that can be used to render the user interface. For example, in some embodiments, code for rendering a user interface can be generated by source code repairer 120 and transmitted to developer computer system 150, and developer computer system 150 can in turn execute the code to render the user interface on its display.

FIG. 6 shows user interface 600 that can be displayed by an IDE executing on developer computer system 150 according to one embodiment. As described above, source code analyzer 110 or source code repairer 120 may notify developer computer system 150 of a potential defect in the code. User interface 600 can include defect indicator 610 which highlights the line of code containing the error. According to some embodiments, defect indicator 610 can be highlighted with a color, such as red, to flag the potential defect. Defect indicator 610 can also contain a textual description of the potential defect. For example, as shown in FIG. 6, defect indicator 610 contains text to indicate the error is a null pointer exception.

According to some embodiments, user interface 600 contains suggested code repair element 620. Suggested code repair element 620 can include text representing a suggested repair for defective source code. Suggested code repair element 620 can be located proximate to defect indicator 610 within user interface 600 indicating that the suggested repair is for the defect indicated by defect indicator 610. The text of suggested code repair element 620 can be highlighted a different color than that of defect indicator 610.

User interface 600 can also include selectable items 630 and 640 which provide the developer an opportunity to accept (selectable item 630) or decline (selectable item 640) the suggested repair provided by suggested code repair element 620. In some embodiments, when a developer selects accept selectable item 630, developer computer system 150 sends a message to source code repairer 120 that the code provided in suggested code repair element 620 is accepted by the developer. Source code repairer 120 can then incorporate the repair in the source code base. Also, following a developer selecting accept selectable item 630, user interface 600 updates to replace the previously defective source code with the source code suggested by suggested code repair element 620.

When a developer selects decline selectable item 640, developer computer system 150 sends a message to source code repairer 120 that the suggested source code repair was not accepted. According to some embodiments, source code repairer 120 may provide an additional suggested code repair to developer computer system 150. In such embodiments, user interface 600 updates suggested code repair element 620 to display the additional suggested code repair. This process may repeat until the developer accepts one of the suggested repairs. In some embodiments, once source code repairer 120 provides all of the suggestions to developer computer system 150, and all of those suggestions have been declined, the first possible suggestion may be provided again to developer computer system 150.

In some embodiments, source code repairer 120 provides a list of suggested code replacements to developer computer system 150. In such embodiments, suggested code repair element 620 can include a drop-down list selection element, or other similar list display user interface element, from which the developer can select a suggested code repair. Once the developer selects a suggested code repair using suggested code repair element 620, the developer may select accept selectable item 630, indicating that the code repair currently displayed by suggested code repair element 620 is to replace the potentially defective code. If the developer chooses not to use any of the suggested repairs, she may select decline selectable item 640.

### Computer System Architecture For Embodiments

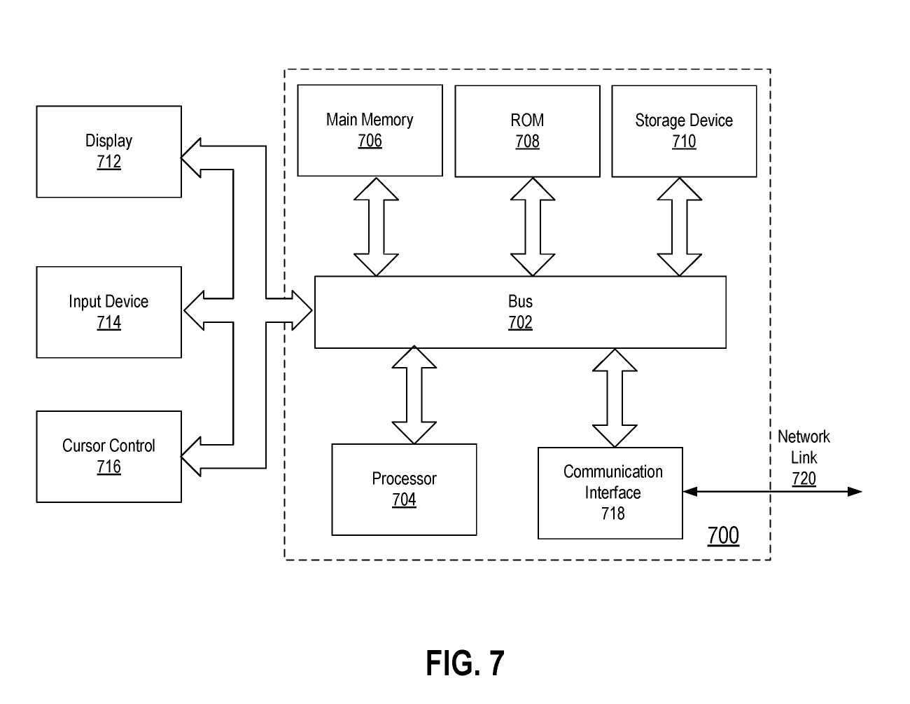

FIG. 7 is a block diagram of an exemplary computer system 700, consistent with embodiments of the present disclosure. The components of system 100, such as source code analyzer 110, source code repairer 120, training source code repository 130, deployment source code repository 140, and developer computer system 150 can include an architecture based on, or similar to, that of computer system 700.

As illustrated in FIG. 7, computer system 700 includes a bus 702 or other communication mechanism for communicating information, and hardware processor 704 coupled with bus 702 for processing information. Hardware processor 704 can be, for example, a general purpose microprocessor. Computer system 700 also includes a main memory 706, such as a random access memory (RAM) or other dynamic storage device, coupled to bus 702 for storing information and instructions to be executed by processor 704. Main memory 706 also can be used for storing temporary variables or other intermediate information during execution of instructions to be executed by processor 704. Such instructions, when stored in non-transitory storage media accessible to processor 704, render computer system 700 into a special-purpose machine that is customized to perform the operations specified in the instructions. Computer system 700 further includes a read only memory (ROM) 708 or other static storage device coupled to bus 702 for storing static information and instructions for processor 704. A storage device 710, such as a magnetic disk or optical disk, is provided and coupled to bus 702 for storing information and instructions.

In some embodiments, computer system 700 can be coupled via bus 702 to display 712, such as a cathode ray tube (CRT), liquid crystal display, or touch screen, for displaying information to a computer user. An input device 714, including alphanumeric and other keys, is coupled to bus 702 for communicating information and command selections to processor 704. Another type of user input device is cursor control 716, such as a mouse, a trackball, or cursor direction keys for communicating direction information and command selections to processor 704 and for controlling cursor movement on display 712. The input device typically has two degrees of freedom in two axes, a first axis (for example, x) and a second axis (for example, y), that allows the device to specify positions in a plane.

Computer system 700 can implement disclosed embodiments using customized hard-wired logic, one or more ASICs or FPGAs, firmware and/or program logic which in combination with the computer system causes or programs computer system 700 to be a special-purpose machine. According to some embodiments, the operations, functionalities, and techniques disclosed herein are performed by computer system 700 in response to processor 704 executing one or more sequences of one or more instructions contained in main memory 706. Such instructions can be read into main memory 706 from another storage medium, such as storage device 710. Execution of the sequences of instructions contained in main memory 706 causes processor 704 to perform process steps consistent with disclosed embodiments. In some embodiments, hard-wired circuitry can be used in place of or in combination with software instructions.

The term “storage media” can refer, but is not limited, to any non-transitory media that stores data and/or instructions that cause a machine to operate in a specific fashion. Such storage media can comprise non-volatile media and/or volatile media. Non-volatile media includes, for example, optical or magnetic disks, such as storage device 710. Volatile media includes dynamic memory, such as main memory 706. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from, but can be used in conjunction with, transmission media. Transmission media participates in transferring information between storage media. For example, transmission media includes coaxial cables, copper wire and fiber optics, including the wires that comprise bus 702. Transmission media can also take the form of acoustic or light waves, such as those generated during radio-wave and infrared data communications.

Various forms of media can be involved in carrying one or more sequences of one or more instructions to processor 704 for execution. For example, the instructions can initially be carried on a magnetic disk or solid state drive of a remote computer. The remote computer can load the instructions into its dynamic memory and send the instructions over a network line communication line using a modem, for example. A modem local to computer system 700 can receive the data from the network communication line and can place the data on bus 702. Bus 702 carries the data to main memory 706, from which processor 704 retrieves and executes the instructions. The instructions received by main memory 706 can optionally be stored on storage device 710 either before or after execution by processor 704.

Computer system 700 also includes a communication interface 718 coupled to bus 702. Communication interface 718 provides a two-way data communication coupling to a network link 720 that is connected to a local network. For example, communication interface 718 can be an integrated services digital network (ISDN) card, cable modem, satellite modem, or a modem to provide a data communication connection to a corresponding type of telephone line. As another example, communication interface 718 can be a local area network (LAN) card to provide a data communication connection to a compatible LAN. Communication interface 718 can also use wireless links. In any such implementation, communication interface 718 sends and receives electrical, electromagnetic or optical signals that carry digital data streams representing various types of information.

Network link 720 typically provides data communication through one or more networks to other data devices. For example, network link 720 can provide a connection through local network 722 to other computing devices connected to local network 722 or to an external network, such as the Internet or other Wide Area Network. These networks use electrical, electromagnetic or optical signals that carry digital data streams. The signals through the various networks and the signals on network link 720 and through communication interface 718, which carry the digital data to and from computer system 700, are example forms of transmission media. Computer system 700 can send messages and receive data, including program code, through the network(s), network link 720 and communication interface 718. In the Internet example, a server (not shown) can transmit requested code for an application program through the Internet (or Wide Area Network) the local network, and communication interface 718. The received code can be executed by processor 704 as it is received, and/or stored in storage device 710, or other non-volatile storage for later execution.

According to some embodiments, source code analyzer 110 and source code repairer 120 can be implemented using a quantum computing system. In general, a quantum computing system is one that makes use of quantum-mechanical phenomena to perform data operations. As opposed to traditional computers that are encoded using bits, quantum computers use qubits that represent a superposition of states. Computer system 700, in quantum computing embodiments, can incorporate the same or similar components as a traditional computing system, but the implementation of the components may be different to accommodate storage and processing of qubits as opposed to bits. For example, quantum computing embodiments can include implementations of processor 704, memory 706, and bus 702 specialized for qubits. However, while a quantum computing embodiment may provide processing efficiencies, the scope and spirit of the present disclosure is not fundamentally altered in quantum computing embodiments.

According to some embodiments, one or more components of source code analyzer 110 and/or source code repairer 120 can be implemented using a cellular neural network (CNN). A CNN is an array of systems (cells) or coupled networks connected by local connections. In a typical embodiment, cells are arranged in two-dimensional grids where each cell has eight adjacent neighbors. Each cell has an input, a state, and an output, and it interacts directly with the cells within its neighborhood, which is defined as its radius. Like neurons in an artificial neural network, the state of each cell in a CNN depends on the input and output of its neighbors, and the initial state of the network. The connections between cells can be weighted, and varying the weights on the cells affects the output of the CNN. According to some embodiments, classifier 114 can be implemented as a CNN and the trained neural network 270 can include specific CNN architectures with weights that have been determined using the embodiments and techniques disclosed herein. In such embodiments, classifier 114, and the operations performed by it, by include one or more computing systems dedicated to forming the CNN and training trained neural network 270.

In the foregoing disclosure, embodiments have been described with reference to numerous specific details that can vary from implementation to implementation. Certain adaptations and modifications of the embodiments described herein can be made. Therefore, the above embodiments are considered to be illustrative and not restrictive.

Furthermore, throughout this disclosure, several embodiments were described as containing modules and/or components. In general, the word module or component, as used herein, refers to logic embodied in hardware or firmware, or to a collection of software instructions, possibly having entry and exit points, written in a programming language, such as, for example, C, C++, or C#, Java, or some other commonly used programming language. A software module may be compiled and linked into an executable program, installed in a dynamic link library, or may be written in an interpreted programming language such as, for example, BASIC, Perl, or Python. It will be appreciated that software modules can be callable from other modules or from themselves, and/or may be invoked in response to detected events or interrupts. Software modules can be stored in any type of computer-readable medium, such as a memory device (e.g., random access, flash memory, and the like), an optical medium (e.g., a CD, DVD, BluRay, and the like), firmware (e.g., an EPROM), or any other storage medium. The software modules may be configured for execution by one or more processors in order to cause the disclosed computer systems to perform particular operations. It will be further appreciated that hardware modules can be comprised of connected logic units, such as gates and flip-flops, and/or can be comprised of programmable units, such as programmable gate arrays or processors. Generally, the modules described herein refer to logical modules that can be combined with other modules or divided into sub-modules despite their physical organization or storage.

What is claimed is:

1. A method for generating a source code defect detector, the method comprising:
obtaining a first version of source code, the first version of the source code including one or more defects;
obtaining a second version of the source code, the second version of the source code including a modification to the first version of the source code, the modification addressing the one or more defects;
generating a plurality of selected control flows based on the first version of the source code and the second version of the source code, the plurality of selected control flows comprising:
first control flows representing potentially defective lines of the source code, and
second control flows including defect-free lines source code;
generating a label set, the label set including data elements corresponding to respective members of the plurality of selected control flows, the data elements representing an indication of whether its respective member of the plurality of selected control flows contains a potential defect or is defect-free; and,
training a neural network using the plurality of selected control flows and the label set.

2. The method of claim 1, wherein generating the plurality of selected control flows includes comparing a first control flow graph corresponding to the first version of source code to a second control flow graph corresponding to the second version of the source code to identify the first control flows and the second control flows.

3. The method of claim 2, further comprising:
generating the first control flow graph by transforming the first version of the source code into a first plurality of control flows; and,
generating the second control flow graph by transforming the second version of the source code into a second plurality of control flows.

4. The method of claim 3, wherein:
transforming the first version of the source code into the first plurality of control flows includes generating a first abstract syntax tree; and
transforming the second version of the source code into the second plurality of control flows includes generating a second abstract syntax tree.

5. The method of claim 4, wherein:
transforming the first version of the source code into the first plurality of control flows includes normalizing variables in the first abstract syntax tree; and
transforming the second version of the source code into the second plurality of control flows includes normalizing variables in the second abstract syntax tree.

6. The method of claim 1, further comprising encoding the plurality of selected control flows into respective vector representations using one-of-k encoding.

7. The method of claim 6, wherein the encoding includes assigning a first subset of the plurality of selected control flows to respective unique vector representations and assigning a second subset of the plurality of selected control flows a vector representation corresponding to an unknown value.

8. The method of claim 1, further comprising encoding the plurality of selected control flows into respective vector representations using an embedding layer.

9. The method of claim 1, further comprising:
obtaining metadata describing one or more defect types;
selecting a defect of the one or more defect types; and
the source code is limited to lines of code including defects of the selected defect.

10. The method of claim 1, wherein the neural network is a recurrent neural network.

11. The method of claim 1, wherein training the neural network includes applying the plurality of selected control flows as input to the neural network and adjusting weights of the neural network so that the neural network produces outputs matching the plurality of selected control flows respective data elements of the label set.

12. A system for detecting defects in source code, the system comprising:
one or more processors; and,
one or more computer readable media storing instructions that when executed by the one or more processors perform operations comprising:
generating one or more control flows for first source code, the one or more control flows corresponding to execution paths within the first source code,
generating a location map linking the one or more control flows to locations within the source code,
encoding the one or more control flows using an encoding dictionary,
identifying faulty control flows by applying the one or more control flows as input to a neural network trained to detect defects in the first source code, wherein the neural network was trained using second source code of the same context as the first source code, the second source code encoded using the encoding dictionary, and
correlating the faulty control flows to fault locations within the first source code based on the location map.

13. The system of claim 12, wherein the operations further comprise providing the fault locations to a developer computer system.

14. The system of claim 13, wherein the fault locations are provided to the developer computer system as instructions for generating a user interface for displaying the fault locations.

15. The system of claim 12, wherein generating the one or more control flows includes generating an abstract syntax tree for the first source code.

16. A method for repairing software defects, the method comprising:
performing one or more defect detection operations on an original source code file to identify a defect in first one or more lines of source code, the defect being of a defect type;
providing the first one or more lines of source code to a first neural network to generate second one or more lines of source code, wherein the first neural network was trained to output suggested source code to repair defective source code of the defect type;
replacing the first one or more lines of source code in the original source code file with the second one or more lines of source code to generate a repaired source code file; and,
validating the second one or more lines of source code by performing the one or more defect detection operations on the repaired source code file.

17. The method of claim 16, wherein the one or more defect detection operations include executing a test suite of test cases against an executable form of the original source code file and the repaired source code file.

18. The method of claim 16, wherein the one or more defect detection operations include applying control flows of source code to a second neural network trained to detect defects of the defect type.

19. The method of claim 16, wherein validating the second one or more lines of source code includes providing the second one or more lines of source code to a developer computer system for acceptance.

20. The method of claim 19, wherein the second one or more lines of source code are provided to the developer computer system with instructions for generating a user interface for displaying:
the first one or more lines of source code;
the second one or more lines of source code; and
a user interface element that when selected communicates acceptance of the second one or more lines of source code.
